(19) United States
(12) Patent Application Publication
(10) Pub. No.: US 2016/0378846 A1
(43) Pub. Date: Dec. 29, 2016

(54) OBJECT BASED STORAGE CLUSTER WITH MULTIPLE SELECTABLE DATA HANDLING POLICIES

(71) Applicant: INTEL CORPORATION, Santa Clara, CA (US)

(72) Inventors: Paul E. Luse, Chandler, AZ (US); John Dickinson, San Francisco, CA (US); Clay Gerrard, San Francisco, CA (US); Samuel Merritt, San Francisco, CA (US)

(73) Assignee: INTEL CORPORATION, Santa Clara, CA (US)

(21) Appl. No.: 14/751,957

(22) Filed: Jun. 26, 2015

(51) Int. Cl. G06F 17/30

(52) U.S. Cl. CPC G06F 17/30598; G06F 17/30312

(57) ABSTRACT

Methods and systems to configure an object-based storage cluster with multiple selectable data handling policies, including to map an object to a storage device/node of the cluster based on the policy associated with the object. In an embodiment, each policy is associated with a respective one of multiple rings, partitions of which are mapped to storage devices of the same cluster, objects are associated with buckets/containers, and each bucket/container is associated within a user-selectable one of the policies, such as with a metadata-based policy index, and an object is mapped to a storage device/node of the cluster based on the ring associated with the policy index of the object's container.

### BACKGROUND

Object based storage, or object storage refers to techniques for accessing, addressing, and/or manipulating discrete units of data, referred to as objects. An object may include text, image, video, audio, and/or other computer accessible/manipulable data.

Object-based storage treats objects on a level or flat address space, referred to herein as a storage pool, rather than, for example, a hierarchical directory/sub-directory/file structure.

Multiple storage devices may be configured/accessed as a unitary object based storage system or cluster

A conventional object-based storage cluster utilizes a consistent hash ring (ring) to map objects to storage devices of the cluster. The ring represents a range of hash indexes. The ring is partitioned into multiple partitions, each representing a portion of the range of hash indexes, and the partitions are mapped or assigned the storage devices of the cluster. A hash index is computed for an object based in part on a name of the object. The hash index is correlated to a partition of the object storage ring, and the object is mapped to the storage device associated with the partition.

The number of partitions may be defined to exceed the number of storage devices, such that each storage device is associated with multiple partitions. In this way, if an additional storage device(s) is to be added to the cluster, a subset of partitions associated with each of the existing storage devices may be re-assigned to the new storage device. Conversely, if a storage device is to be removed from a cluster, partitions associated with the storage device may be re-assigned to other devices of the cluster.

An object-based storage cluster may include a replicator to replicate data (e.g., on a partition basis), based on a replication policy of the cluster (e.g., 3× replication). An object and its replicas may assigned to different partitions.

A replicator may be configured to provide eventual consistency (i.e., ensuring that all instances of an object are consistent with one another over time). Eventual consistency favors partition tolerance and availability over immediate consistency. Eventual consistency is useful in cluster based object storage due, in part to potentially large number of partitions that may become unavailable from time to time due to device and/or power failures.

A conventional object-based storage cluster applies the same (i.e., a single) replication policy across the entire cluster. Additional data replication policies may be provided by additional respective clusters, each including a corresponding set of resources (e.g., storage devices, proxy tier resources, load balancers, network infrastructure, and management/monitoring frameworks). Multiple clusters may be relatively inefficient in that resources of one or more of the clusters may be under-utilized, and/or resources of one or more other the clusters may be over-utilized.

### BRIEF DESCRIPTION OF THE DRAWINGS

For illustrative purposes, one or more features disclosed herein may be presented and/or described by way of example and/or with reference to one or more drawing figured listed below. Methods and systems disclosed herein are not, however, limited to such examples or illustrations.

FIG. 1 is a flowchart of a method of mapping objects to an object based storage cluster based on selectable data handling policies associated with containers of the objects.

FIG. 2 is a block diagram of an object based storage cluster that includes multiple storage devices and a system to map objects to the storage devices based on data handling policies associated with containers of the objects.

FIG. 3 is a flowchart of a method of mapping objects to storage devices based on multiple object storage rings, each of which may be associated with a respective one of multiple data handling policies.

FIG. 4 is a conceptual illustration of a partitioned object storage ring.

FIG. 5 is a block diagram of an object based storage cluster that includes a system to map objects to storage devices based on multiple object storage rings, each of which may be associated with a respective one of multiple selectable data handling policies.

FIG. 6 is a block diagram of a computer system configured to map objects to storage devices based on multiple object storage rings and/or multiple data handling policies.

FIG. 7 is a conceptual illustration of mappings or associations between partitions of object storage rings and storage devices.

FIG. 8 is another conceptual illustration of partition-to-device mappings.

In the drawings, the leftmost digit(s) of a reference number identifies the drawing in which the reference number first appears.

### DETAILED DESCRIPTION

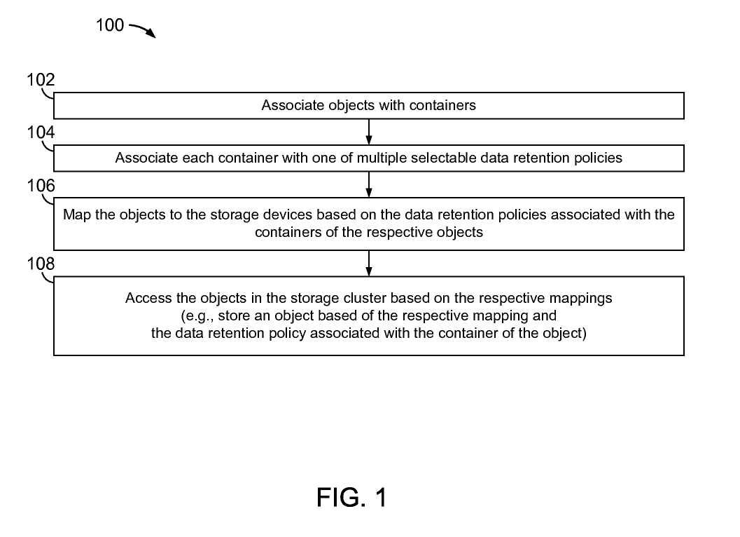

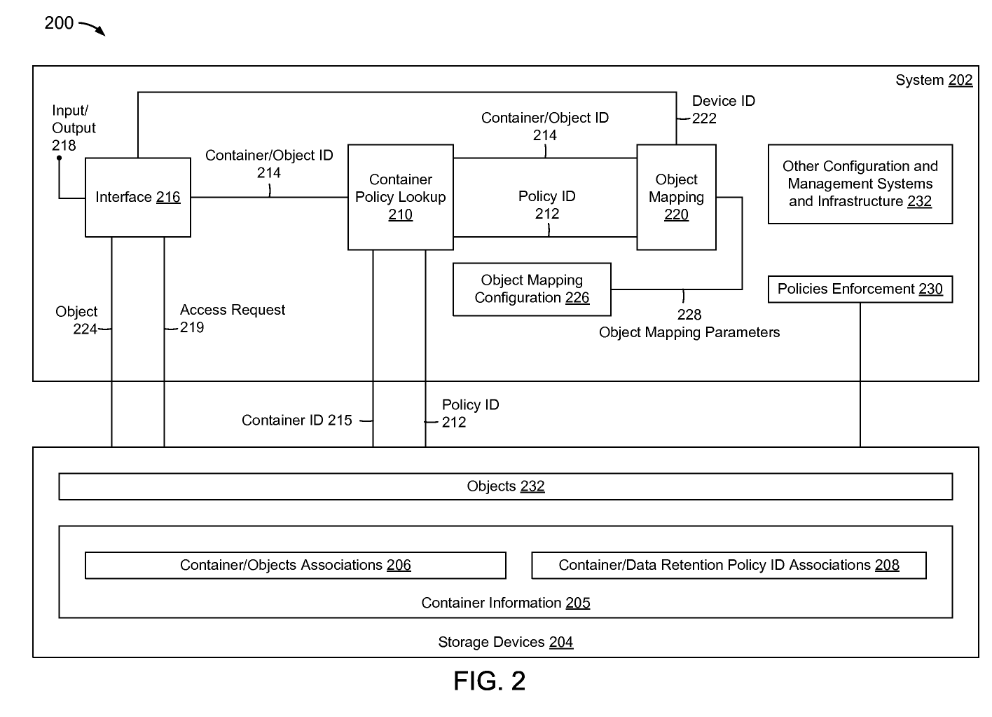

FIG. 1 is a flowchart of a method 100 of mapping objects to an object based storage cluster based on selectable data handling policies, where each object is associated with a hierarchical storage construct, referred to herein as a bucket, bin, container object, or container, and each container is associated with a selectable one of the multiple data handling policies. Method 100 is described below with reference to FIG. 2. Method 100 is not, however, limited to the example of FIG. 2.

FIG. 2 is a block diagram of an object based storage cluster 200 that includes multiple storage devices 204 and a system 202 to map objects to storage devices 204 based on data handling policies associated with containers of the objects. Object based storage cluster 200 may be configured as a distributed eventually consistent object based storage cluster.

Method 100 and/or system 202 may be useful, for example, to provide multiple user selectable data handling policies without duplication of resources such as, without limitation, storage devices, proxy tier resources, load balancers, network infrastructure, and management/monitoring frames works.

At 104, each container is associated with one of multiple selectable data handling policies.

A data handling policy may relate to data/object distribution, placement, replication, retention, deletion, compression/de-duplication, latency/throughput, and/or other factor(s). A data handling policy may include, without limitation, a data replication parameter (e.g., number of replications and/or replication technology/algorithm (e.g., erasure code)), a retention time parameter, a storage location parameter (e.g., a device, node, zone, and/or geographic parameter), and/or other data handling parameter(s). Example data handling policies are further provided below. Data handling policies are not, however, limited to the examples provided herein.

A container may be associated with a data handling policy based on user input.

Each container may be represented as container object or construct, such as a database, and objects of a container may be recorded within the respective container object, or construct.

Association of a container with a data handling policy may include populating a metadata field of the container database with one of multiple policy indexes, where each policy index corresponds to a respective one of the data handling policies.

In FIG. 2, system 202 includes an interface 216 to interface with users and/or other systems/devices. Interface 216 may include and/or represent a proxy tier resource. Interface 216 may receive access requests through an input/output (I/O) 218. An access request may include, without limitation, a request to write/store an object, read/retrieve, copy an object, and/or delete an object. Interface 216 may be configured to provide a requested object through I/O 218.

Interface 216 may be configured invoke other resources of system 202 to create containers, associate the containers with accounts, associate data handling policies with the containers, associate objects with the containers, map the objects to storage devices 205, and/or access the objects based on the respective mappings.

Information related to the containers, illustrated here as container information 205, may be stored in one or more storage devices 204, and/or other storage device(s). In the example of FIG. 2, container information 205 includes container/object associations 206, and container/data handling policy ID associations 208.

At 106 in FIG. 1, objects are mapped to (e.g., associated with) storage devices based at least in part on the data handling policy associated with the container of the respective object.

In FIG. 2, system 202 includes a container policy lookup engine 210 to receive a container/object ID 214 from interface 216, and to retrieve a data handling policy index or identifier (policy ID) 212 based on a container ID 215 portion of container/object ID 214.

Container/object ID 214 may be in a form of a pathname, which may be represented as/{container name}/{object name}. Where containers are associated with accounts, an account/container/object ID may be represented as/{account name}/{container name}/{object name}.

Where containers are associated with accounts, and container/object ID 214 may include an account ID (e.g., /{account name}/{container name}/{object name}), and container policy lookup engine 210 may be configured to retrieve retention policy ID 212 based further on the account ID.

System 202 further includes an object mapping engine 220 to map container/object IDs 214 to storage devices 204 based on policy IDs 212 retrieved for the respective container/object IDs 214. For each container/object ID 214 and corresponding policy ID 212, object mapping engine 220 returns a device ID 222 to interface 216. Device ID 222 may correspond to a storage device 202, a storage node (e.g., a storage server associated with one or more of storage devices 204), a storage zone, and/or other designated feature(s)/aspect(s) of storage devices 204.

System 202 may further include an object mapping configuration engine 226 to provide object mapping parameters 228 to object mapping engine 220, examples of which are provided further below with respect to object storage rings.

At 108 in FIG. 1, objects are accessed within storage devices 204 based on the respective mappings determined at 106. When an object is to be stored in storage devices 204, accessing at 108 includes storing the object based on the data handling policy associated with the container of the object.

In FIG. 2, interface 216 is configured to send an access instruction or access request 219 to a storage device 202 based on device ID 222. When an object is to be written/stored, interface 216 provides the object, illustrated here as object 224, to the storage device.

System 202 further includes a policies enforcement engine 230 to enforce data handling policies associated with containers. Policies enforcement engine 230 may include a replication engine to replicate objects 232 of a container based on a data handling policy associated with the container. Policies enforcement engine 230 may be configured to provide eventual consistency amongst objects 232 and replicas of the objects, in accordance with data handling policies of the respective containers.

System 202 may further include other configuration and management systems and infrastructure 232, which may include, without limitation, proxy tier resources, load balancers, network infrastructure, maintenance resources, and/or monitoring resources.

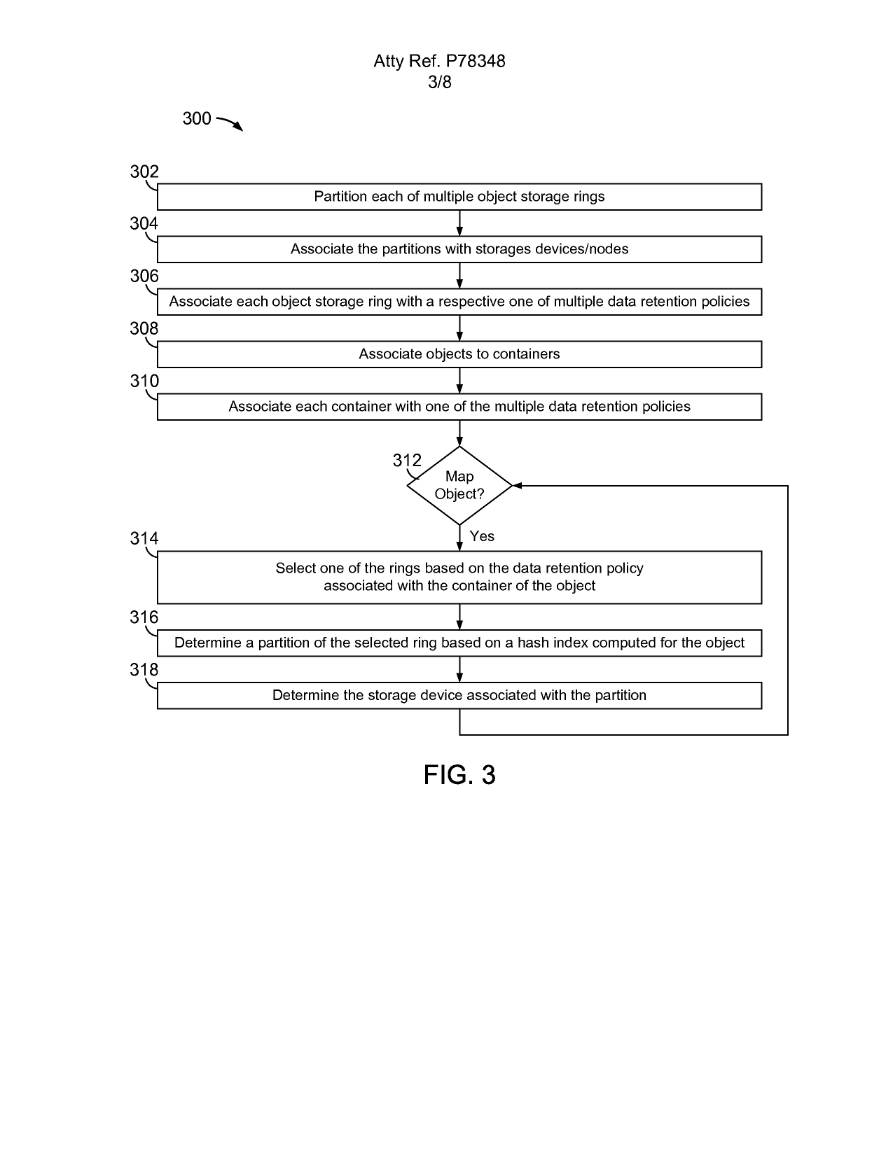

Method 100 may be performed as described below with reference to FIG. 3. Method 100 is not, however, limited to the example of FIG. 3.

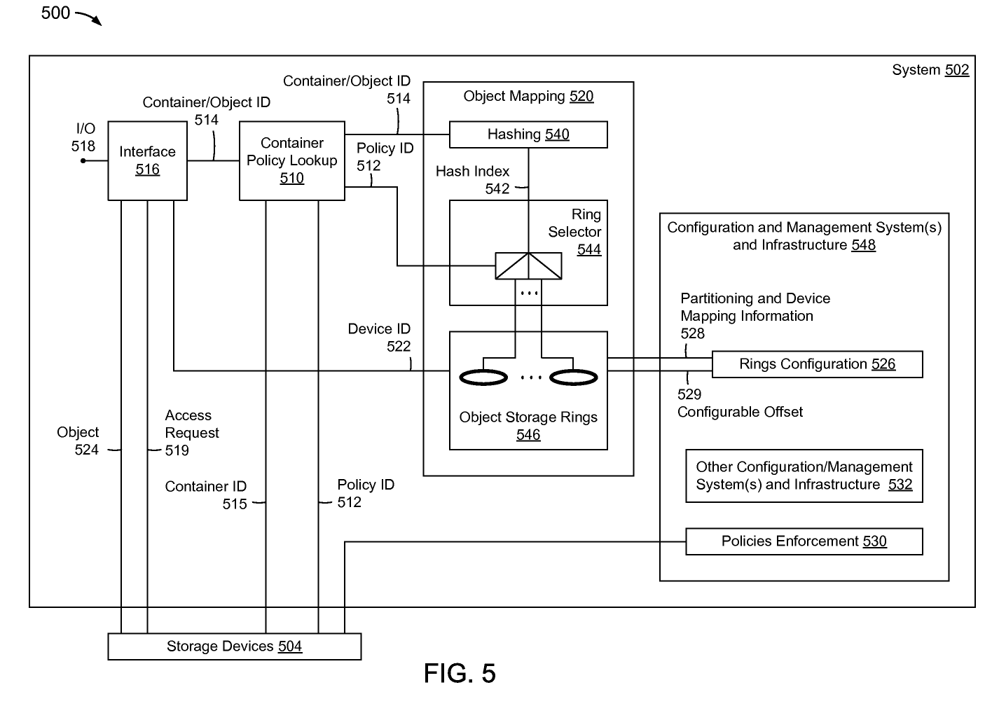

System 200 may be configured as described below with reference to FIG. 5. System 202 is not, however, limited to the example of FIG. 5.

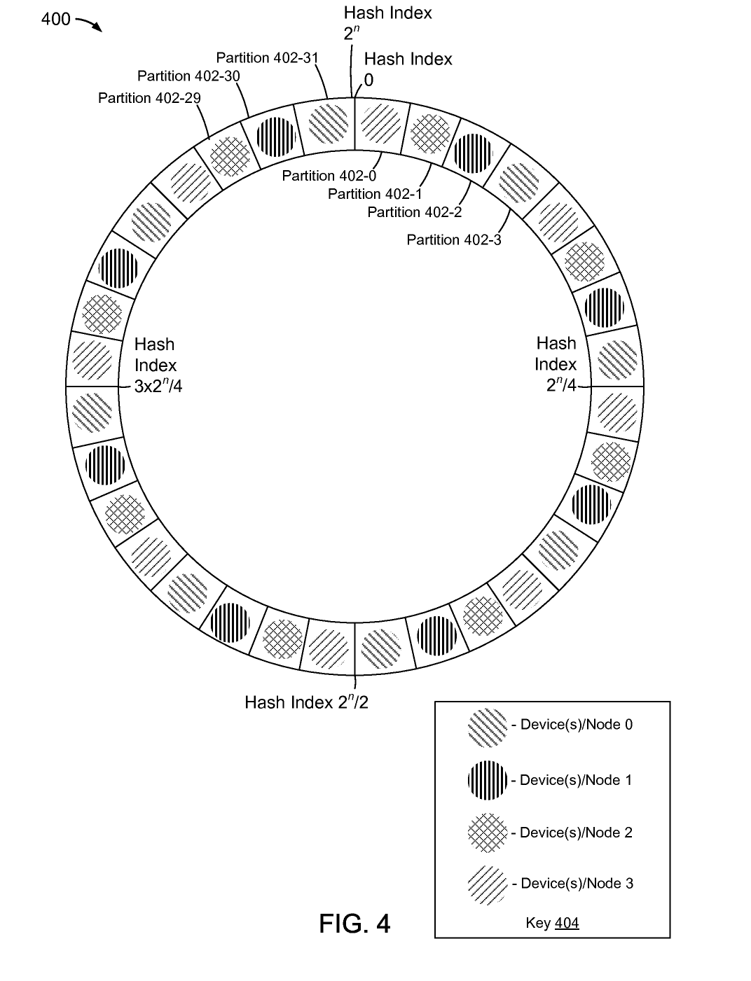

FIG. 3 is a flowchart of a method 300 of mapping objects to storage devices based on multiple object storage rings. As described above, each object storage ring may be associated with a respective one of multiple selectable data handling policies. Method 300 is described below with reference to FIG. 4. Method 300 is not, however, limited to the example of FIG. 4.

FIG. 4 is a conceptual illustration of an object storage ring (ring) 400. Ring 400 may represent a static data structure. Ring 400 represents a range of hash values or indexes (a hash range), illustrated here as 0 through 2″, where n is a positive integer. Ring 400 may represent a consistent hash ring.

Each of the object storage rings may represent a unique or distinct hash range, relative to one another.

At 302 in FIG. 3, each ring is partitioned into multiple partitions, where each partition represents a portion of the hash range of the respective ring. A ring may be partitioned into 2 or more partitions.

In FIG. 4, ring 400 is partitioned into 32 partitions 402-0 through 402-31, for illustrative purposes.

The rings may be partitioned into the same number of partitions, or one or more of the rings may be partitioned into a number of partitions that differs from a number of partitions of one or more other ones of the rings.

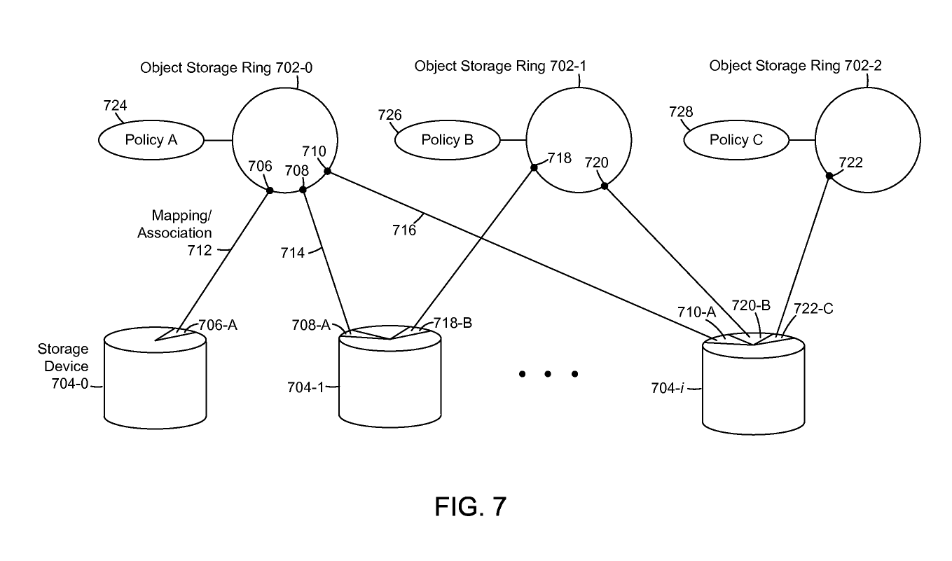

At 304 in FIG. 3, the partitions of the rings are mapped to (i.e., assigned to or associated with) storage devices. A partition may be mapped to a list or set of one or more physical storage devices. A storage device may be associated one or multiple object storage rings, examples of which are provided further below with reference to FIG. 7.

In FIG. 4, each partition 402 of ring 400 is illustrated with one of four types of shading, and a key 404 is provided, to illustrate mapping of the respective partitions to one of four sets of storage devices or nodes. The number four is used here for illustrative purposes. Partitions 402 may be mapped (or re-mapped) to one or more storage devices/nodes.

In the example of FIG. 4, partitions 402 are mapped to device(s)/node 0 through device(s)/node 3 in a cyclical pattern. Partitions 402 and/or partitions of other ones of the multiple object storage rings may be mapped to storage devices/nodes based on another pattern(s), and/or in a random or pseudo-random fashion.

At 306 in FIG. 3, each object storage ring is associated with a respective one of multiple data handling policies.

At 308, objects are associated with containers, such as described above with respect to 104 in FIG. 1.

At 310, each container is associated with one of the multiple data handling policies, such as described above with respect to 106 in FIG. 1.

At 312, when an object is to be mapped to a storage device/node, one of the multiple object storage rings is selected at 314 based on the data handling policy associated with the container of the object.

At 316, a partition of the selected object storage ring is determined based on a hash index computed for the object.

At 318, the storage device associated with the partition determined at 316 is determined. The storage device determined at 318, or a corresponding device ID, represents a mapping of the object, which may be used to access the object (i.e., to write/store and/or read/retrieve the object).

FIG. 5 is a block diagram of an object based storage cluster 500 that includes a system 502 to map objects to storage devices 504 based on multiple object storage rings. Each object storage ring may be associated with a respective one of multiple selectable data handling policies. Object based storage cluster 500 may be configured as a distributed eventually consistent object based storage cluster.

System 502 includes an interface 516 to interface with users and/or other systems/devices through an I/O 518, such as described above with respect to interface 216 in FIG. 2.

System 502 further includes a container policy lookup engine 510 to retrieve a policy ID 512 based on a container ID 515 and/or an account ID, such as described above with respect to container policy lookup engine 210 in FIG. 2.

System 502 further includes an object mapping engine 520 to map container/object IDs 514 to storage devices 504 based on policy IDs 512 retrieved for the respective container/object IDs 514. For each container/object ID 514 and corresponding policy ID 512, object mapping engine 520 returns a device ID 522.

Object mapping engine 520 includes multiple object storage rings 546. Object storage rings 546 may be partitioned as described above with respect to 302 in FIG. 3, and the partitions may be mapped to storage devices 504 as described above with respect to 304 in FIG. 3. Each object storage ring 546 may be associated with a respective one of multiple data handling policies, such as described above with respect to 306 in FIG. 3.

Object mapping engine 520 further includes a hashing engine 540 to compute a hash index 542 based on container/object ID 514, and a ring selector 544 to select one of object storage rings 546 based on policy ID 512. Object mapping engine 520 is configured to determine a partition of a selected object storage ring based on hash index 542, and to determine a device ID 522 of a storage device 504 associated with the partition.

Object mapping engine 520 may be configured to determine a partition of a selected object storage ring based on a combination of hash index 542 and one/or more other values and/or parameters. Object mapping engine 520 may, for example, be configured to determine a partition of a selected object storage ring based on a combination of a portion of hash index 542 and a configurable offset 529. Configurable offset 529 may be determined based on a number of partitions of the selected object storage ring, and may be correspond to a partition power or partition count.

System 502 further includes configuration and management system(s) and infrastructure 548.

In the example of FIG. 5, configuration and management system(s) and infrastructure 548 includes a rings configuration engine 550 to provide partitioning and device mapping information or parameters 528 and configurable offset 529 to object mapping engine 520.

Configuration and management system(s) and infrastructure 548 may further include a policies enforcement engine 530 to enforce policies associated with containers and/or object storage rings 546.

System 502 may further include a container server to map container databases to storage devices 504 based on container IDs 515 and a container ring.

System 502 may further include an account server to map account databases to storage devices 504 based on account IDs and an account ring.

One or more features disclosed herein may be implemented in circuitry, a machine, a computer system, a processor and memory, a computer program encoded within a computer-readable medium, and/or combinations thereof. Circuitry may include discrete and/or integrated circuitry, application specific integrated circuitry (ASIC), a system-on-a-chip (SOC), and combinations thereof. Information processing by software may be concretely realized by using hardware resources.

One or more features described herein may be integrated within a computer program and/or a suite of computer programs configured to cause a processor to access multiple storage devices as an object based storage cluster, such as, for example and without limitation, a suite of computer programs known as OpenStack, available at OpenStack.org.

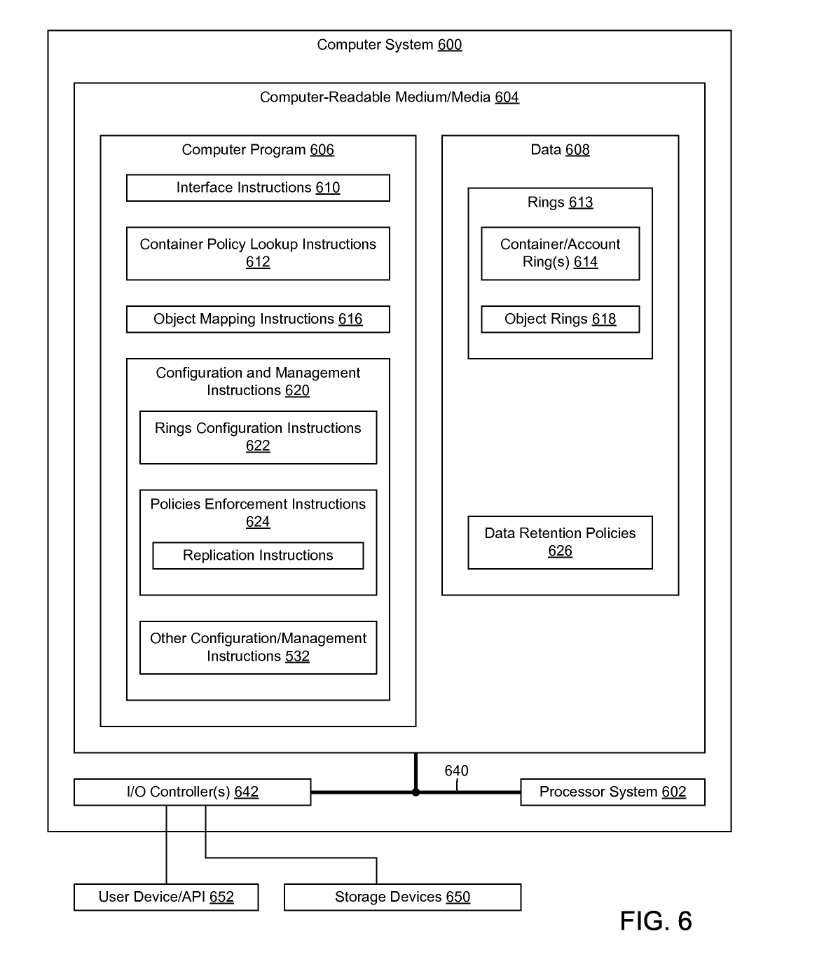

FIG. 6 is a block diagram of a computer system 600, configured to map objects to storage devices 650 based on multiple object storage rings and/or multiple data handling policies.

Computer system 600 may represent an example embodiment or implementation of system 202 in FIG. 2 and/or system 502 in FIG. 5.

Computer system 600 includes one or more processors, illustrated here as a processor 602, to execute instructions of a computer program 606 encoded within a computer readable medium 604. Computer readable medium 604 may include a transitory or non-transitory computer-readable medium.

Processor 602 may include one or more instruction processors and/or processor cores, and a control unit to interface between the instruction processor(s)/core(s) and computer readable medium 604. Processor 602 may include, without limitation, a microprocessor, a graphics processor, a physics processor, a digital signal processor, a network processor, a front-end communications processor, a co-processor, a management engine (ME), a controller or microcontroller, a central processing unit (CPU), a general purpose instruction processor, and/or an application-specific processor.

In FIG. 6, computer readable medium a 604 further includes data 608, which may be used by processor 602 during execution of computer program 606, and/or generated by processor 602 during execution of computer program 606.

In the example of FIG. 6, computer program 606 includes interface instructions 610 to cause processor 602 to interface with users and/or other systems/devices, such as described in one or more examples herein.

Computer program 606 further includes container policy lookup instructions to cause processor 602 to determine policy, such as described in one or more examples herein. Container policy lookup instructions 612 may include instructions to cause processor 602 to reference a container database ring and/or an account database ring, collectively illustrated here as container/account ring(s) 614.

Computer program 606 further includes object mapping instructions 616 to cause processor 602 to map objects to storage devices 650. Object mapping instructions 616 may include instructions to cause processor 602 to map objects to storage devices 650 based on multiple object rings 618, such as described in one or more examples herein.

Computer program 606 further includes configuration and management instructions 620.

In the example of FIG. 6, configuration and management instructions 620 include rings configuration instructions 622 to cause processor 602 to define, partition, and map rings 613, such as described in one or more examples herein.

Configuration and management instructions 620 further include policies enforcement instructions 624 to cause processor 602 to enforce data handling policies 626, such as described in one or more examples herein.

Computer system 600 further includes communications infrastructure 640 to communicate amongst devices and/or resources of computer system 600.

Computer system 600 further includes one or more input/output (I/O) devices and/or controllers (I/O controllers) 642 to interface storage devices 650 and/or a user device/application programming interface (API) 652.

A storage device may be associated with one or multiple object storage rings, and/or with one or multiple data handling policies, such as described below with reference to FIGS. 7.

FIG. 7 is a conceptual illustration of mappings or associations between partitions of object storage rings 702 and storage devices 704. Partitions 706, 708, and 710 of ring 702-0 are mapped to storage devices 704-0, 704-1, and 704-1, respectively. This is illustrated by respective mappings or associations 712, 714, and 716. Partitions 718 and 720 of ring 702-1 are mapped to storage devices 704-1 and 704-1, respectively. Partition 722 of ring 702-2 is mapped to storage device 704-1.

A partition of a ring may be mapped to a portion, area, or region of a storage device based on a data handling policy of the ring. This may be useful to permit multiple object storage rings to share a storage device (i.e., to map partitions of multiple object storage rings to the same storage device). Stated another way, this may be useful to permit a storage device to support multiple data handling policies.

The area or region may be conceptualized as, and/or may correspond to a directory of the storage device. The area may be named based on an identifier of the partition (e.g., a partition number), and an identifier of a data handling policy associated with the ring (e.g., a policy index). The partition number may, for example, be appended with a policy index.

In FIG. 7, ring 702-0 is associated with a data handling policy 724 (Policy A). Ring 702-1 is associated with a data handling policy 726 (Policy B). Ring 702-2 is associated with a data handling policy 728 (Policy C).

Further in FIG. 7, partition 706 of ring 702-0 is mapped to an area 706-A of storage device 704-0. A name of area 706 may be assigned/determined by appending a partition number of partition 706 with an index associated with Policy A.

Further in FIG. 7, partition 708 of ring 702-0 is mapped to an area 708-A of storage device 704-1. Partition 710 of ring 702-0 is mapped to an area 710-A of storage device 704-i. Partition 718 of ring 702-1 is mapped to an area 718-B of storage device 704-1. Partition 720 of ring 702-1 is mapped to an area 720-B of storage device 704-i. Partition 722 of ring 702-2 is mapped to an area 722-C of storage device 704-i.

In the example of FIG. 7, storage device 704-0 thus supports Policy A. Storage device 704-1 supports Policies A and B. Storage device 704-i supports Policies A, B, and C.

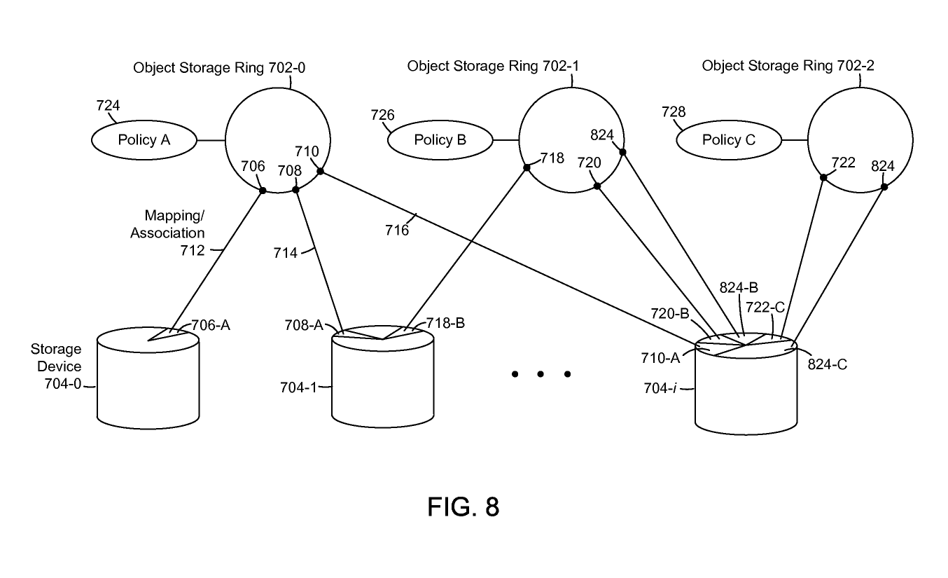

Mapping partitions to storage devices based on a combination of partition identifiers and policy identifiers provides unique identifiers for each partition. Thus, even identical partition numbers of multiple rings may be mapped to the same storage device. An example is provided below with reference to FIG. 8.

FIG. 8 is a conceptual illustration of the partition-to-device mappings of FIG. 7, where rings 702-1 and 702-2 each include an identical partition number, represented here as 824, which are mapped to storage device 704-i. Specifically, partition 824 of ring 702-1 is mapped to an area 824-B of storage device 704-i, whereas partition 824 of ring 702-2 is mapped to an area 824-C of storage device 704-i. In this example, “824-B” represents the partition number appended with an identifier or index of Policy B, and “824-C” represents the partition number appended with an identifier or index of Policy C.

The examples of FIGS. 7 and 8 are provided for illustrative purposes. Methods and systems disclosed herein are not limited to the examples of FIG. 7 or FIG. 8.

An object based storage cluster may be configured with multiple data handling policies, which may include one or more of:
a policy to store and replicate objects of a container;
a policy to store objects of a container without replication;
a first policy to maintain a first number of replicas of objects of a container, and a second policy to maintain a second number of replicas of objects of a container, wherein the first and second numbers differ from one another;
a policy to store objects of a container in a compressed format;
a policy to store objects of a container in a storage device that satisfies a geographic location parameter;
a policy to store objects of a container in a storage device that satisfies a geographic location parameter without replication of the objects;
a policy to store and replicate objects of a container and distribute the stored objects and replicas of the objects in multiple respective zones of the object-based storage cluster, wherein the zones are defined with respect to one or more of storage device identifiers, storage device types, server identifiers, power grid identifiers, and geographical locations;
a policy to store and replicate objects of a container, archive the objects of the container after a period of time, and discard the stored objects and replicas of the stored objects after archival of the respective objects;
a policy to store and replicate objects of a container, archive the objects of the containers based on an erasure code after a period of time, and discard the stored objects and replicas of the stored objects after archival of the respective objects; and/or
a policy to map objects of a container to a storage system that is external to the object-based storage cluster through an application-programming interface of the external storage system.

One or more other data handling policies may be defined.

A data handling policy may be defined and/or selected based on a legal requirement.

A data handling policy may be defined and/or selected based on a disaster recovery consideration(s).

A policy may be assigned to a container when the container is created.

Each container may be provided with an immutable metadata element referred to as a storage policy index (e.g., an alpha and/or numerical identifier). When a container is created, a header may be provided to specify one of multiple policy indexes. If no policy index is specified for when a new container is created, a default policy may be assigned to the container. Human readable policy names may be presented to users, which may be translated to policy indexes (e.g., by a proxy server). Any of the multiple data replication policies may be set as the default policy.

A policy index may be reserved and/or utilized for a purpose other than a replication policy. This may be useful, for example, where a legacy cluster (i.e., having single object ring and single replication policy applied across the cluster), is modified to include multiple object storage rings (e.g., to support multiple data handling policies). In this example, a unique policy index may be reserved to access objects of legacy containers that are not associated with data handling policies.

Containers may have a many-to-one relationship with policies, meaning that multiple of containers can utilize the same policy.

An object based storage cluster configured with multiple selectable data handling polices may be further configured to expose the multiple data handling policies to an interface application(s) (e.g., a user interface and/or an application programming interface), based on an application discovery and understanding (ADU) technique. For example, where a computer program includes instructions to perform method 100 in FIG. 1 and/or method 300 in FIG. 3 (or a portion thereof), and an ADU application may be used to analyze artifacts of the computer program to determine metadata structures associated with the computer program (e.g., lists of data elements and/or business rules). Relationships discovered between the computer program and a central metadata registry may be stored in the metadata registry for use by the interface application(s).

An object based storage system, as disclosed herein, may be configured to permit different storage devices to be associated with, or belong to different object rings, such as to provide multiple respective levels of data replication.

An object based storage system configured with multiple object storage rings may be useful to segment a cluster of storage devices for various purposes, examples of which are provided herein.

Multiple data handling policies and/or multiple object storage rings may be useful to permit an application and/or a deployer to essentially segregate object storage within a single cluster.

Multiple data handling policies and/or multiple object storage rings may be useful to provide multiple levels of replication within a single cluster. If a provider wants to offer, for example, 2× replication and 3× replication, but doesn't want to maintain 2 separate clusters, a single cluster may be configured with a 2× policy and a 3× policy.

Multiple data handling policies and/or multiple object storage rings may be useful for performance purposes. For example, whereas conventional solid-state disks (SSDs) may be used as the exclusive members of an account or database ring, an SSD-only object ring may be created and used to provide a low-latency/high performance policy.

Multiple data handling policies and/or multiple object storage rings may be useful to collect a set of nodes into a group. Different object rings may have different physical servers so that objects associated with a particular policy are placed in a particular data center or geography.

Multiple data handling policies and/or multiple object storage rings may be useful to support multiple storage techniques. For example, a set of nodes may that use a particular data storage technique or diskfile (i.e., a backend object storage plug-in architecture), which may differ from an object based storage technique. In this example, a policy may be configured for the set of notes to direct traffic just to those nodes.

Multiple data handling policies and/or multiple object storage rings may provide better efficiency relative to multiple single-policy clusters.

In examples herein, data handling policies are described as applied at a container level. Alternatively, or additionally, multiple data handling policies may be applied at another level(s), such as at an object level.

Application of data handling policies at a container level may be useful to permit an interface application to utilize the policies with relative ease.

Application of policies at the container level may be useful to allow for minimal application awareness in that, once a container has been created and associated with a policy, all objects associated with the container will be retained in accordance with the policy.

Where an existing single-policy storage cluster is re-configured to include multiple selectable storage policies, applying policies at the container level may be useful to avoid changes to authorization systems currently in use.

### EXAMPLES

The following examples pertain to further embodiments.

An Example 1 is a method of providing multiple data handling policies within a cluster of storage devices managed as an object based storage cluster, that includes assigning data objects to container objects, associating each of the container objects with one of multiple selectable data handling policies, and assigning each data object to a region of a storage device within the cluster of storage devices based in part on the data handling policy associated with the container object of the respective data object.

In an Example 2, the method further includes managing the data objects within the cluster of storage devices based on the data handling policies of the respective container objects.

In an Example 3, the assigning each data object includes assigning a data object of a container object associated with a first one of the data handling policies to a first region of a first one of the storage devices, and assigning a data object of a container associated with a second one of the data handling policies to a second region of the first storage device.

In an Example 4, the assigning each data object includes selecting one of multiple consistent hash rings based on the data handling policy associated with the container of a data object, and assigning the data object to a region of a storage device based on the selected consistent hash ring.

In an Example 5, the method further includes: partitioning each of multiple consistent hash rings into multiple partitions, where each partition represents a range of hash indexes of the respective hash ring, associating each of the consistent hash rings with a policy identifier of a respective one of the data handling policies, and associating each partition of each consistent hash ring with a region of one of the storage devices based on a partition identifier of the respective partition and the policy identifier of the respective consistent hash ring; and the assigning each data object includes selecting one of the consistent hash rings for a data object based on the data handling policy associated with the container of the data object, computing a hash index for the data object, determining a partition of the selected consistent hash ring based on the hash index, and assigning the data object to the region of the storage device associated with the partition.

In an Example 6, the partition identifier of a partition of a first one of the consistent hash rings is identical to the partition identifier of a partition of a second one of the consistent hash rings, and the associating each partition includes associating the partition of the first consistent hash ring with a first region of a first one of the storage devices based on the partition identifier and the policy identifier of the first consistent hash ring, and associating the partition of the second consistent hash ring with a second region of the first storage device based on the partition identifier and the policy identifier of the second consistent hash ring.

In an Example 7, the associating each of the container objects includes associating one of multiple data handling policy identifiers to each container object as metadata, where each data handling policy identifier corresponds to a respective one of the data handling policies.

An Example 8 is a computing device comprising a chipset according to any one of Examples 1-7.

An Example 9 is an apparatus configured to perform the method of any one of Examples 1-7.

An Example 10 is an apparatus comprising means for performing the method of any one of Examples 1-7.

An Example 11 is a machine to perform the method of any one of Examples 1-7.

An Example 12 is at least one machine-readable medium comprising a plurality of instructions that, when executed on a computing device, cause the computing device to carry out a method according to any one of Examples 1-7.

An Example 13 is a communications device arranged to perform the method of any one of Examples 1-7.

An Example 14 is a computer system to perform the method of any of Examples 1-7.

An Example 15 is an apparatus that includes a processor and memory configured to provide multiple data handling policies within a cluster of storage devices managed as an object based storage cluster, including to assign data objects to container objects, associate each of the container objects with one of multiple selectable data handling policies, and assign each data object to a region of a storage device within the cluster of storage devices based in part on the data handling policy associated with the container object of the respective data object.

In an Example 16, the processor and memory are further configured to manage the data objects within the cluster of storage devices based on the data handling policies of the respective container objects.

In an Example 17, the processor and memory are further configured to assign a data object of a container object associated with a first one of the data handling policies to a first region of a first one of the storage devices, and assign a data object of a container associated with a second one of the data handling policies to a second region of the first storage device.

In an Example 18, the processor and memory are further configured to select one of multiple consistent hash rings based on the data handling policy associated with the container of a data object, and assign the data object to a region of a storage device based on the selected consistent hash ring.

In an Example 19, the processor and memory are further configured to partition each of multiple consistent hash rings into multiple partitions, where each partition represents a range of hash indexes of the respective hash ring, associate each of the consistent hash rings with a policy identifier of a respective one of the data handling policies, associate each partition of each consistent hash ring with a region of one of the storage devices based on a partition identifier of the respective partition and the policy identifier of the respective consistent hash ring, select one of the consistent hash rings for a data object based on the data handling policy associated with the container of the data object, compute a hash index for the data object, determine a partition of the selected consistent hash ring based on the hash index, and assign the data object to the region of the storage device associated with the partition.

In an Example 20, the partition identifier of a partition of a first one of the consistent hash rings is identical to the partition identifier of a partition of a second one of the consistent hash rings, and the processor and memory are further configured to associate the partition of the first consistent hash ring with a first region of a first one of the storage devices based on the partition identifier and the policy identifier of the first consistent hash ring, and associate the partition of the second consistent hash ring with a second region of the first storage device based on the partition identifier and the policy identifier of the second consistent hash ring.

In an Example 21, the processor and memory are further configured to associate one of multiple data handling policy identifiers to each container object as metadata, where each data handling policy identifier corresponds to a respective one of the data handling policies.

An Example 22 is a non-transitory computer readable medium encoded with a computer program, including instructions to cause a processor to provide multiple data handling policies within a cluster of storage devices managed as an object based storage cluster, including to assign data objects to container objects, associate each of the container objects with one of multiple selectable data handling policies, and assign each data object to a region of a storage device within the cluster of storage devices based in part on the data handling policy associated with the container object of the respective data object.

An Example 23 includes instructions to cause the processor to manage the data objects within the cluster of storage devices based on the data handling policies of the respective container objects.

An Example 24 includes instructions to cause the processor to assign a data object of a container object associated with a first one of the data handling policies to a first region of a first one of the storage devices, and assign a data object of a container associated with a second one of the data handling policies to a second region of the first storage device.

An Example 25 includes instructions to cause the processor to select one of multiple consistent hash rings based on the data handling policy associated with the container of a data object, and assign the data object to a region of a storage device based on the selected consistent hash ring.

An Example 26 includes instructions to cause the processor to partition each of multiple consistent hash rings into multiple partitions, where each partition represents a range of hash indexes of the respective hash ring, associate each of the consistent hash rings with a policy identifier of a respective one of the data handling policies, associate each partition of each consistent hash ring with a region of one of the storage devices based on a partition identifier of the respective partition and the policy identifier of the respective consistent hash ring, select one of the consistent hash rings for a data object based on the data handling policy associated with the container of the data object, compute a hash index for the data object, determine a partition of the selected consistent hash ring based on the hash index, and assign the data object to the region of the storage device associated with the partition.

In an Example 27, the partition identifier of a partition of a first one of the consistent hash rings is identical to the partition identifier of a partition of a second one of the consistent hash rings, and the instruction include instructions to cause the processor to associate the partition of the first consistent hash ring with a first region of a first one of the storage devices based on the partition identifier and the policy identifier of the first consistent hash ring, and associate the partition of the second consistent hash ring with a second region of the first storage device based on the partition identifier and the policy identifier of the second consistent hash ring.

An Example 28 includes instructions to cause the processor to associate one of multiple data handling policy identifiers to each container object as metadata, where each data handling policy identifier corresponds to a respective one of the data handling policies.

In an Example 29, the data handling policies of any one of Examples 1-28 include one or more of:
a policy to store and replicate data objects of a container object and
a policy to store data objects of a container object without replication;
a policy to maintain a first number of replicas of data objects of a container object, and a policy to maintain a second number of replicas of data objects of a container object, where the first and second numbers differ from one another;
a policy to store data objects of a container object in a compressed format;
a policy to store data objects of a container object in a storage device that satisfies a geographic location parameter;
a policy to store data objects of a container object in a storage device that satisfies a geographic location parameter without replication of the data objects;
a policy to store and replicate data objects of a container object and distribute the stored data objects and replicas of the data objects in multiple respective zones of the cluster of storage devices, where the zones are defined with respect to one or more of storage device identifiers, storage device types, server identifiers, power grid identifiers, and geographical locations;
a policy to map data objects of a container object to a storage system that is external to the cluster of storage devices;
a policy to store and replicate data objects of a container object, archive the data objects of the container object after a period of time, and discard the stored data objects and replicas of the stored data objects after archival of the respective data objects; and
a policy to store and replicate data objects of a container object, archive the data objects of the container object based on an erasure code after a period of time, and discard the stored data objects and replicas of the stored data objects after archival of the respective data objects.

Methods and systems are disclosed herein with the aid of functional building blocks illustrating functions, features, and relationships thereof. At least some of the boundaries of these functional building blocks have been arbitrarily defined herein for the convenience of the description. Alternate boundaries may be defined so long as the specified functions and relationships thereof are appropriately performed. While various embodiments are disclosed herein, it should be understood that they are presented as examples. The scope of the claims should not be limited by any of the example embodiments disclosed herein.

What is claimed is:

1. A machine-implemented method, comprising:
assigning data objects to container objects;
associating each of the container objects with one of multiple selectable data handling policies; and
assigning each data object to a region of a storage device within the cluster of storage devices based in part on the data handling policy associated with the container object of the respective data object.

2. The method of claim 1, further including:
managing the cluster of storage devices as an object based storage cluster, including managing the data objects within the cluster of storage devices based on the data handling policies of the respective container objects.

3. The method of claim 1, wherein the assigning each data object includes:
assigning a data object of a container object associated with a first one of the data handling policies to a first region of a first one of the storage devices; and
assigning a data object of a container associated with a second one of the data handling policies to a second region of the first storage device.

4. The method of claim 1, wherein the assigning each data object includes:
selecting one of multiple consistent hash rings based on the data handling policy associated with the container of a data object; and
assigning the data object to a region of a storage device based on the selected consistent hash ring.

5. The method of claim 1, further including:
partitioning each of multiple consistent hash rings into multiple partitions, wherein each partition represents a range of hash indexes of the respective hash ring;
associating each of the consistent hash rings with a policy identifier of a respective one of the data handling policies; and
associating each partition of each consistent hash ring with a region of one of the storage devices based on a partition identifier of the respective partition and the policy identifier of the respective consistent hash ring;
wherein the assigning each data object includes selecting one of the consistent hash rings for a data object based on the data handling policy associated with the container of the data object, computing a hash index for the data object, determining a partition of the selected consistent hash ring based on the hash index, and assigning the data object to the region of the storage device associated with the partition.

6. The method of claim 5, wherein the partition identifier of a partition of a first one of the consistent hash rings is identical to the partition identifier of a partition of a second one of the consistent hash rings, and wherein the associating each partition includes:
associating the partition of the first consistent hash ring with a first region of a first one of the storage devices based on the partition identifier and the policy identifier of the first consistent hash ring; and
associating the partition of the second consistent hash ring with a second region of the first storage device based on the partition identifier and the policy identifier of the second consistent hash ring.

7. The method of claim 1, wherein the associating each of the container objects includes:
associating one of multiple data handling policy identifiers to each container object as metadata, wherein each data handling policy identifier corresponds to a respective one of the data handling policies.

8. An apparatus, comprising, a processor and memory configured to:
assign data objects to container objects;
associate each of the container objects with one of multiple selectable data handling policies; and
assign each data object to a region of a storage device within the cluster of storage devices based in part on the data handling policy associated with the container object of the respective data object.

9. The apparatus of claim 8, wherein the processor and memory are further configured to manage the cluster of storage devices as an object based storage cluster, including to manage the data objects within the cluster of storage devices based on the data handling policies of the respective container objects.

10. The apparatus of claim 8, wherein the processor and memory are further configured to:
assign a data object of a container object associated with a first one of the data handling policies to a first region of a first one of the storage devices; and
assign a data object of a container associated with a second one of the data handling policies to a second region of the first storage device.

11. The apparatus of claim 8, wherein the processor and memory are further configured to:
select one of multiple consistent hash rings based on the data handling policy associated with the container of a data object; and
assign the data object to a region of a storage device based on the selected consistent hash ring.

12. The apparatus of claim 8, wherein the processor and memory are further configured to:
partition each of multiple consistent hash rings into multiple partitions, wherein each partition represents a range of hash indexes of the respective hash ring;
associate each of the consistent hash rings with a policy identifier of a respective one of the data handling policies;
associate each partition of each consistent hash ring with a region of one of the storage devices based on a partition identifier of the respective partition and the policy identifier of the respective consistent hash ring;
select one of the consistent hash rings for a data object based on the data handling policy associated with the container of the data object;
compute a hash index for the data object;
determine a partition of the selected consistent hash ring based on the hash index; and
assign the data object to the region of the storage device associated with the partition.

13. The apparatus of claim 12, wherein the partition identifier of a partition of a first one of the consistent hash rings is identical to the partition identifier of a partition of a second one of the consistent hash rings, and wherein the processor and memory are further configured to:
associate the partition of the first consistent hash ring with a first region of a first one of the storage devices based on the partition identifier and the policy identifier of the first consistent hash ring; and
associate the partition of the second consistent hash ring with a second region of the first storage device based on the partition identifier and the policy identifier of the second consistent hash ring.

14. The apparatus of claim 8, wherein the processor and memory are further configured to associate one of multiple data handling policy identifiers to each container object as metadata, wherein each data handling policy identifier corresponds to a respective one of the data handling policies.

15. A non-transitory computer readable medium encoded with a computer program, that includes instructions to cause a processor to:
assign data objects to container objects;
associate each of the container objects with one of multiple selectable data handling policies; and
assign each data object to a region of a storage device within the cluster of storage devices based in part on the data handling policy associated with the container object of the respective data object.

16. The non-transitory computer readable medium of claim 15, further including instructions to cause the processor to:
manage the cluster of storage devices as an object based storage cluster, including to manage the data objects within the cluster of storage devices based on the data handling policies of the respective container objects.

17. The non-transitory computer readable medium of claim 15, further including instructions to cause the processor to:
assign a data object of a container object associated with a first one of the data handling policies to a first region of a first one of the storage devices; and
assign a data object of a container associated with a second one of the data handling policies to a second region of the first storage device.

18. The non-transitory computer readable medium of claim 15, further including instructions to cause the processor to:
select one of multiple consistent hash rings based on the data handling policy associated with the container of a data object; and
assign the data object to a region of a storage device based on the selected consistent hash ring.

19. The non-transitory computer readable medium of claim 15, further including instructions to cause the processor to:
partition each of multiple consistent hash rings into multiple partitions, wherein each partition represents a range of hash indexes of the respective hash ring;
associate each of the consistent hash rings with a policy identifier of a respective one of the data handling policies;
associate each partition of each consistent hash ring with a region of one of the storage devices based on a partition identifier of the respective partition and the policy identifier of the respective consistent hash ring;
select one of the consistent hash rings for a data object based on the data handling policy associated with the container of the data object;
compute a hash index for the data object;
determine a partition of the selected consistent hash ring based on the hash index; and
assign the data object to the region of the storage device associated with the partition.

20. The non-transitory computer readable medium of claim 19, wherein the partition identifier of a partition of a first one of the consistent hash rings is identical to the partition identifier of a partition of a second one of the consistent hash rings, further including instructions to cause the processor to:
associate the partition of the first consistent hash ring with a first region of a first one of the storage devices based on the partition identifier and the policy identifier of the first consistent hash ring; and
associate the partition of the second consistent hash ring with a second region of the first storage device based on the partition identifier and the policy identifier of the second consistent hash ring.
